(19) United States
(12) Patent Application Publication
(10) Pub. No.: US 2025/0177840 A1
(43) Pub. Date: Jun. 5, 2025

(54) SPORTS GLOVES

(71) Applicant: Sangha LEE, Yongin-si (KR)

(72) Inventor: Sangha LEE, Yongin-si (KR)

(21) Appl. No.: 18/837,589

(22) PCT Filed: Feb. 3, 2023
(86) PCT No.: PCT/KR2023/001597

§ 371 Date: Aug. 26, 2024

(30) Foreign Application Priority Data
Feb. 11, 2022 (KR) 10-2022-0018347

(51) Int. Cl. A63B 71/14; A63B 102/32

(52) U.S. Cl. CPC A63B 71/14; A63B 2102/32; A63B 2209/00

(57) ABSTRACT

As a sports glove according to an embodiment of the present disclosure, there is provided a sports glove, including a support disposed on a portion of the palm part of the glove; wherein the support is configured such that the width thereof measured on a vertical plane, through which a first imaginary line connecting a thumb connection portion and a hand blade portion on the palm part passes, becomes narrower in a direction toward the hand blade portion along the first imaginary line.

### TECHNICAL FIELD

The present disclosure relates to a sports glove for securely holding a club, a stick, a pole, or a bike handle used in sports activities such as golf, fishing, skiing, mountaineering, and bike riding.

### BACKGROUND ART

The sports glove according to the present disclosure relates to a sports glove that is worn when a user grips a golf club, a fishing rod, a ski stick, a hiking pole, or a bike handle. In particular, recently, the general public's interest in golf has increased, and the number of golfers has increased in line with the trend toward the popularization of golf. Accordingly, research on functional golf equipment for improving golfers' golf skills is actively being conducted.

Golf has various ways of hitting, various postures for holding golf clubs, and various swing methods, so that, unless predetermined postures are maintained, accurate shots may not be expected. The posture for holding a golf club is called a grip, and the grip is related to all the elements of swings, such as the trajectory of a ball, the angle of a club face, the position of a ball, and posture. Accordingly, in order to maintain consistent shots, the grip needs to be consistent and also needs to be securely held with a shaft. Therefore, there is a demand for sports gloves for securely gripping golf clubs.

Furthermore, sports gloves for maintaining a secure grip on a fishing rod while reducing gripping force are required for fishing, which requires the long-term handling of the fishing rod, as well as golf. Moreover, there are required sports gloves for gripping ski poles, hiking sticks, or bike handles to improve safety.

### DISCLOSURE

### Technical Problem

The present disclosure has been contrived in response to the above-described background technology, and a sports glove according to the present disclosure includes a support, and enables a user to stably hold each club or stick when playing a sport using a sports club or stick, such as golf, fishing, bike riding, skiing, or mountaineering.

In particular, a sports glove according to the present disclosure includes a support, so that, when a user grips a golf club, the support supports the handle of the golf club. Accordingly, during a fast golf swing, the golf club may be prevented from moving or shaking in the palm, and an accurate swing may be made.

However, the objects to be achieved in the present disclosure are not limited to the objects mentioned above, and other objects not mentioned may be clearly understood based on the following description.

### Technical Solution

There is disclosed a sports glove according to an embodiment of the present disclosure for achieving the above-described objects.

As a sports glove according to an embodiment of the present disclosure, there is provided a sports glove, including a support disposed on a portion of the palm part of the glove; wherein the support is configured such that the width thereof measured on a vertical plane, through which a first imaginary line connecting a thumb connection portion and a hand blade portion on the palm part passes, becomes narrower in a direction toward the hand blade portion along the first imaginary line.

In the present embodiment, there is provided the sports glove, wherein the support includes a polyurethane foam material.

In the present embodiment, there is provided the sports glove, wherein the support is disposed on the inner side of the outer skin of the palm part and is also disposed to protrude upward from the palm part of the glove, and the horizontal width of the support measured on the vertical plane becomes narrower in the upward direction.

In the present embodiment, there is provided the sports glove, wherein the support is disposed between outer and inner skins of the palm part of the glove.

In the present embodiment, there is provided the sports glove, wherein the support includes: a top surface; and a first inclined portion formed by taking a downward slope from one side of the top surface toward a little finger connection portion.

In the present embodiment, there is provided the sports glove, wherein the first inclined portion is formed to be rounded such that the slope thereof becomes gentler in the downward direction.

In the present embodiment, there is provided the sports glove, wherein the support includes a second inclined portion formed by taking a downward slope from one side of the top surface toward the thumb connection portion.

In the present embodiment, there is provided the sports glove, wherein the support includes a third inclined portion formed by taking a downward slope from one side of the top surface toward a wrist portion.

In the present embodiment, there is provided the sports glove, wherein the support is disposed between the thumb connection portion and the hand blade portion, and is also disposed closer to the hand blade portion.

In the present embodiment, there is provided the sports glove, wherein the support is disposed between a ring finger connection portion and a little finger connection portion, and a wrist portion, and is also disposed closer to the wrist portion.

### Advantageous Effects

The sports glove according to the present disclosure includes the support, and enables a user to stably hold each club or stick when playing a sport using a sports club or stick, such as golf, fishing, bike riding, skiing, or mountaineering.

In particular, the sports glove according to the present disclosure includes the support, so that when a user grips a golf club, the support supports the handle of the golf club. Accordingly, during a fast golf swing, the golf club may be prevented from moving or shaking in the palm, and an accurate swing may be made.

### DESCRIPTION OF DRAWINGS

FIG. 1 is a drawing showing a sports glove according to an embodiment of the present disclosure;

FIG. 2 is a drawing showing the inside of a sports glove according to an embodiment of the present disclosure;

FIGS. 3 to 5 are drawings showing a support according to an embodiment of the present disclosure;

FIG. 6 is a drawing illustrating the function of a sports glove according to an embodiment of the present disclosure;

FIG. 7 is a diagram illustrating how to use a sports glove according to an embodiment of the present disclosure;

FIG. 8 is a drawing showing a state in which a fishing rod is gripped with a sports glove according to an embodiment of the present disclosure;

FIG. 9 is a diagram showing a state in which a bike handle is gripped with a sports glove according to an embodiment of the present disclosure; and

FIG. 10 is a drawing showing a sports glove according to another embodiment of the present disclosure.

### BEST MODE

Embodiments of the present disclosure will be described in detail with reference to the accompanying drawings below so that those having ordinary skill in the art to which the present disclosure pertains can easily practice the present disclosure. The embodiments proposed in the present disclosure are provided such that those skilled in the art can utilize or practice the content of the present disclosure. Accordingly, various modifications to the embodiments of the present disclosure will be apparent to those skilled in the art. That is, the present disclosure may be implemented in various different forms and is not limited to the embodiments below.

Throughout the specification of the present disclosure, identical or similar reference symbols refer to identical or similar components. Furthermore, in order to clearly describe the present disclosure, the reference symbols of parts that are not related to the description of the disclosure may be omitted in the drawings.

The term “or” used herein is intended to mean an inclusive “or” rather than an exclusive “or.” That is, unless otherwise specified in the present disclosure or unless the meaning is clear from the context, a case where “X uses A or B” should be understood to mean either of the natural inclusive permutations. For example, unless otherwise specified in the present disclosure or unless the meaning is clear from the context, a case where “X uses A or B” may be interpreted as either a case where X uses A, a case where X uses B, or a case where X uses both A and B.

The term “at least one of A and B” used herein should be interpreted to refer to all combinations of A, B, and A and B.

The term “and/or” used herein should be understood to refer to and include all possible combinations of one or more of the related concepts listed.

The terms “include” and/or “including” used herein should be understood to mean that a particular feature and/or component is present. However, it should be understood that the terms “include” and/or “including” do not exclude the presence or addition of one or more other features, one or more other components, and/or combinations thereof.

In the present disclosure, unless otherwise specified or unless the context is clear as to whether a singular form is indicated, the singular form should generally be interpreted as including “one or more.”

The term “N-th (N is a natural number)” used herein may be understood as an expression used to mutually distinguish the components of this disclosure according to a predetermined criterion such as a functional perspective, a structural perspective, or convenience of description. For example, components performing different functional roles in the present disclosure may be distinguished as a first component or a second component. However, components that are substantially the same within the technical concept of this disclosure but should be distinguished for convenience of description may also be distinguished as a first component or a second component.

Meanwhile, the term “module” or “unit” used herein may be understood as a term referring to an independent functional unit that processes resources, such as a computer-related entity, firmware, software or a part thereof, hardware or a part thereof, a combination of software and hardware, or the like. In this case, the “module” or “unit” may be a unit composed of a single element, or a unit expressed as a combination or set of multiple elements. For example, in a narrow sense, a “module” or “unit” may refer to a hardware element of a device or a set of hardware elements, an application program performing a specific function of software, a processing process implemented through the execution of software, a set of instructions for the execution of a program, or the like. In addition, in a broad sense, a “module” or “unit” may refer to a device itself constituting a part of a system, a program itself executed on a device, or the like. However, the above-described concepts are only examples, and the concept of “module” or “part” may be variously defined within a scope understandable to those skilled in the art based on the content of the present disclosure.

The above descriptions of the terms are intended to help to understand the present disclosure. Accordingly, when the above-described terms are not explicitly described as the items limiting the content of the present disclosure, it should be noted that the content of the present disclosure is not used to limit the technical spirit.

A sports glove 10 according to an embodiment of the present disclosure will be described in detail below.

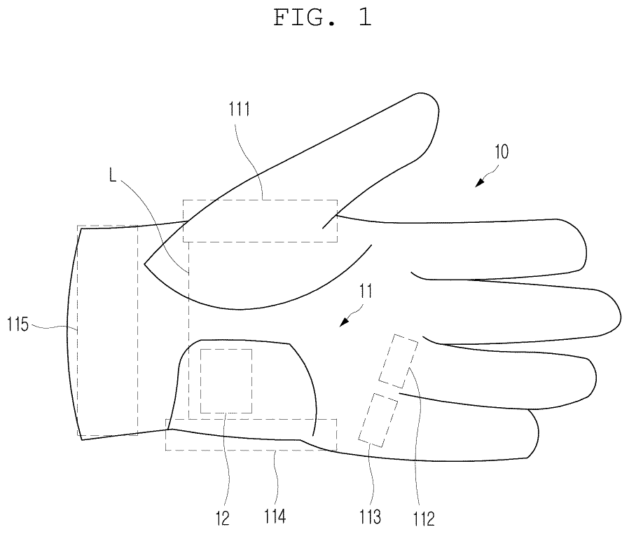

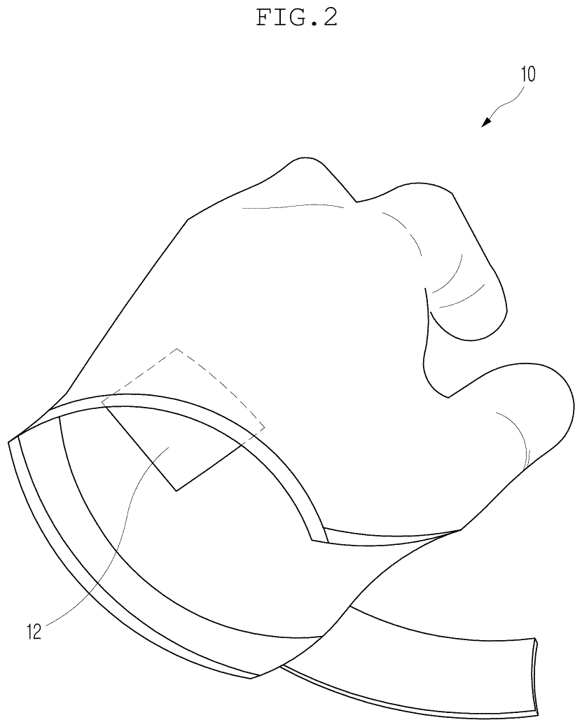

FIG. 1 is a drawing showing a sports glove 10 according to an embodiment of the present disclosure. FIG. 2 is a drawing showing the inside of a sports glove 10 according to an embodiment of the present disclosure.

Referring to FIGS. 1 and 2, the sports glove 10 of the present invention has the overall shape of a glove 10, and may include a finger part (for which a reference symbol is not shown) configured such that five fingers enter it, a back part (for which a reference symbol is not shown) configured such that the back of a hand is placed thereon inside the glove 10, and a palm part 11 configured such that the palm is placed thereon. The back part may include an attachment fixation portion (for which a reference symbol is not shown) configured to bring the glove 10 into contact with the hand and press an insertion portion in order to prevent the hand from being removed when the hand is inserted inside the glove 10.

The palm part 11 may include a thumb connection portion 111, a ring finger connection portion 112, a little finger connection portion 113, a hand blade portion 114, a wrist portion 115, and a patch portion 116.

The thumb connection portion 111 may refer to the portion where the portion of the finger part, into which the thumb is inserted, and the palm part 11 are connected to each other. The ring finger connection portion 112 may refer to the portion where the portion of the finger part, into which the ring finger is inserted, and the palm part 11 are connected to each other. The little finger connection portion 113 may refer to the portion where the portion of the finger part, into which the little finger is inserted, and the palm part 11 are connected to each other. In this manner, the palm part 11 may also include an index finger connection portion (for which a reference symbol is not shown) where the portion of the finger part, into which the index finger is inserted, and the palm part 11 are connected to each other, and a middle finger connection portion (for which a reference symbol is not shown) where the portion of the finger part, into which the middle finger is inserted, and the palm part 11 are connected to each other. However, these are not necessary for the description of the features of the present disclosure, so that detailed descriptions thereof will be omitted.

The hand blade portion 114 may be the portion where the hand blade is placed when the hand is inserted into the glove 10. The wrist portion 115 may be the portion where the wrist is placed when the hand is inserted into the glove 10. The patch portion 116 may be the portion where cotton, leather, etc. are added to a portion of the palm part 11 adjacent to the mount of the Moon of the palm of the hand when the hand is inserted into the glove 10. When a golf swing is practiced using the sports glove 10, a portion of the palm part 11 corresponding to the mount of the Moon of the palm of the hand and a portion adjacent to the hand blade portion 114 may be worn or torn. To prevent this, durability is improved by adding the patch portion 116 to a portion of the palm part 11.

Furthermore, the sports gloves 10 may include a support 12 arranged on a portion of the palm part 11. The support 12 may be a member for improving the support force for an object to be gripped by the hand, such as a golf club, a hiking stick, a bicycle handle, or the like.

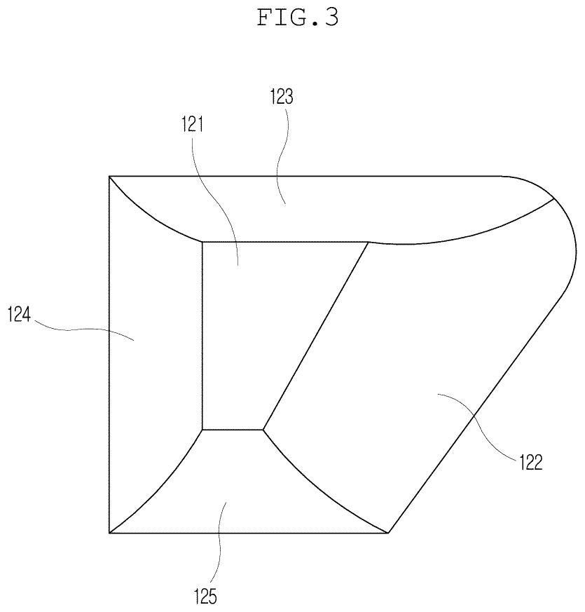

FIGS. 3 to 5 are drawings showing the support 12 according to an embodiment of the present disclosure.

Referring to FIGS. 3 to 5, the support 12 may include a polyurethane foam material. Since the support 12 needs to support a sports stick or pole such as a golf club on the inner side of the outer skin of the glove 10, a specific or higher level of hardness is required. For example, when foamed styrene or sponge is used as the material of the support 12, it is difficult to support a hard stick for a long time and it is difficult to fix the position of the stick. Accordingly, the support 12 is made to include polyurethane foam as the material thereof so that it can support a hard stick for a long time. Among polyurethane foams, hard polyurethane foam may be most suitably used because it has high hardness. Furthermore, the support 12 may include various materials as well as polyurethane foam.

The support 12 may be disposed on the inner side of the outer skin of the palm part 11, and may be arranged to have a shape that protrudes upward from the palm part 11. The support 12 may be disposed between the outer and inner skins of the palm part 11 of the glove 10. That is, the glove 10 may have the support 12 disposed on its inner side, and may include an inner skin to cover it. The inner skin may be made of a material that has a comfortable fit, such as thin leather or cotton.

The support 12 may include a top surface portion 121, a first inclined portion 122, a second inclined portion 123, a third inclined portion 124, and a fourth inclined portion 125. The top surface portion 121 is a flat portion formed on the top of the support 12, and may be a portion that comes into direct contact with the inner surface of the palm part 11. The overall shape of the top surface 121 may be a trapezoid or a triangle when viewed from above.

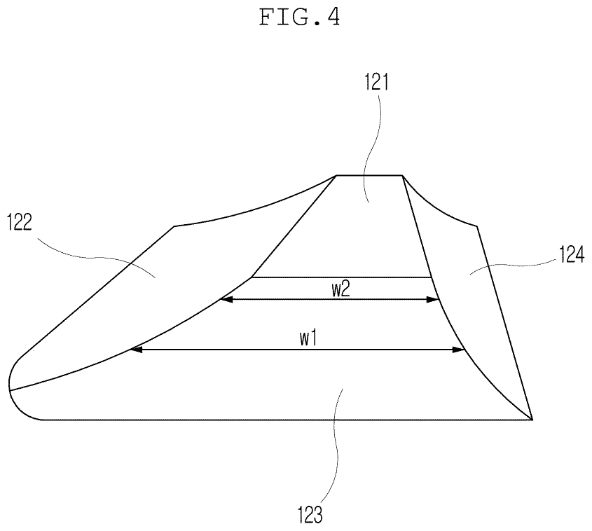

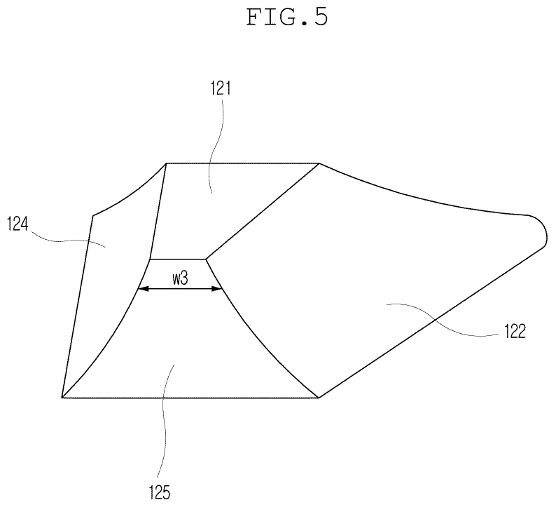

Referring to FIGS. 4 and 5, the support 12 may be configured such that the width (w2>w3) thereof measured on a vertical plane, through which a first imaginary line L connecting the thumb connection portion 111 and the hand blade portion 114 on the palm part 11 passes, becomes narrower in a direction toward the hand blade portion 114 along the first imaginary line L. That is, in the case where the top surface portion 121 has a trapezoidal shape, it may specifically have an isosceles trapezoidal shape, the longer one of the two parallel sides may be disposed close to the thumb connection portion 111, and the shorter side may be disposed close to the hand blade portion 114. In the case where the top surface portion 121 has a triangle shape, it may specifically have a right triangle shape, one side of the right angle may be disposed close to the thumb connection portion 111, and a vertex opposite to it may be disposed close to the hand blade portion 114.

The first inclined portion 122 may be a portion formed by taking a downward slope from one side of the top surface 121 toward the little finger connection portion 113. In the case where the top surface portion 121 has an isosceles trapezoid or right triangle shape, the first inclined portion may be a portion formed by taking a downward slope from the hypotenuse of the top surface portion 121 toward the little finger connection portion 113. Meanwhile, the direction in which the hypotenuse extends horizontally may be directed between the thumb connection portion 111 and the index finger connection portion. As a result, the first inclined portion 122 may be disposed to extend in a direction corresponding to the direction in which a golf club or the like, which is disposed to pass between the thumb and the index finger, extends.

The first inclined portion 122 may be formed to be round so that the slope thereof becomes gentler in the downward direction. Accordingly, the area of contact between various types of sports sticks or handles, which mostly have a cylindrical shape, and the outer surface of the palm part 11 corresponding to the first inclined portion 122 may be expanded and the sticks or handles are seated, so that support force can be improved. Furthermore, the slope of the first inclined portion 122 may become steeper in the direction from the second inclined portion 123 to the fourth inclined portion 125, which will be described later. In order to improve the gripping force and wearing comfort of a sports stick, the first inclined portion 122 may be formed such that the area thereof adjacent to the second inclined portion 123 is wide and the area thereof adjacent to the fourth inclined portion 125 is small.

The second inclined portion 123 may be a portion formed by taking a downward slope from one side of the top surface portion 121 toward the thumb connection portion 111. The second inclined portion 123 may be disposed close to the thumb connection portion 111.

The third inclined portion 124 may be a portion formed by taking a downward slope from one side of the top surface portion 121 toward the wrist portion 115. The third inclined portion 124 may be disposed close to the wrist portion 115.

The fourth inclined portion 125 may be a portion formed by taking a downward slope from one side of the top surface portion 121 toward the hand blade portion 114. The fourth inclined portion 125 may be disposed close to the hand blade portion 114.

Referring to FIG. 4, the width (w1>w2) of the support 12 measured on a vertical plane may become narrower in the upward direction. That is, the area of the bottom surface of the support 12 may be larger than the area of the top surface thereof.

The support 12 is disposed between the thumb connection portion 111 and the hand blade portion 114, and may be disposed closer to the hand blade portion 114. Furthermore, the support 12 is disposed between the ring finger connection portion 112 and the little finger connection portion 113, and the wrist portion 115, and may be disposed closer to the wrist portion 115. The support 12 may be disposed on a portion of the palm part 11 corresponding to the mount of the Moon of the palm of the hand. In this case, the support 12 may come into contact with and support a sports stick that is generally supported by the mount of the Moon of the palm of the hand, thereby improving the support force and reducing the fatigue of the palm.

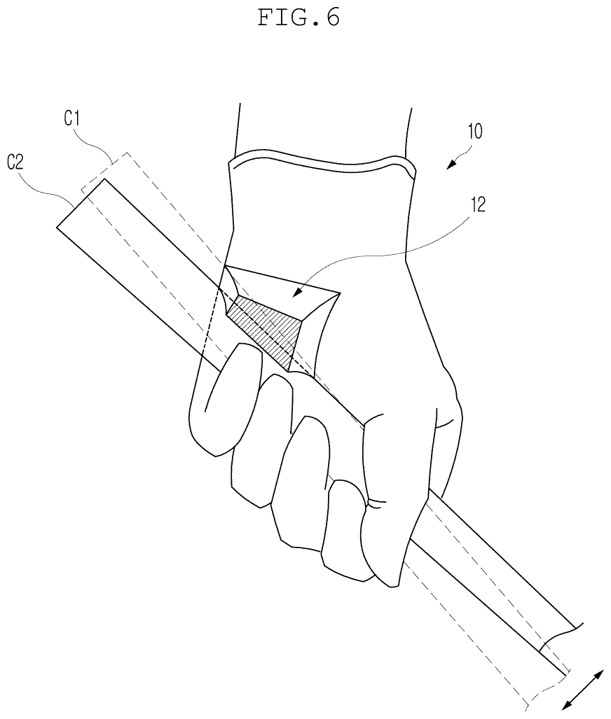

FIG. 6 is a drawing illustrating the function of a sports glove 10 according to an embodiment of the present disclosure.

Referring to FIG. 6, the position at which a sports stick is disposed may be determined depending on whether the support 12 of the sports glove 10 is present. In this case, the sports stick will be described using a golf club as an example. First, when the sports glove 10 does not have a support 12, the golf club may be placed and held as indicated by C1. In this case, when the golf club is swung strongly, the gripping force of the hand is weakened, and the grip of the golf club may be shaken and moved in the palm due to the weight of the club head. In this case, the accuracy with which a golf ball is hit may be reduced.

However, the sports glove 10 according to the present embodiment in which the support 12 is present in the sports glove 10 may allow the golf club to be positioned and gripped as indicated by C2. In this case, the golf club is securely fixed on the palm by the support 12, so that there is no shaking even when a strong golf swing is made. Accordingly, the accuracy and consistency with which a golf ball is hit may be improved.

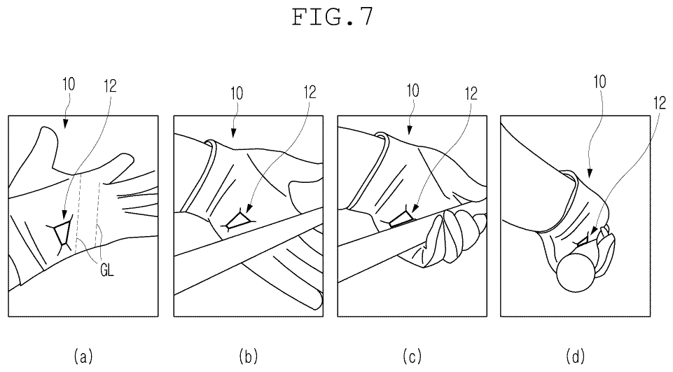

FIG. 7 is a diagram illustrating how to use a sports glove 10 according to an embodiment of the present disclosure.

Referring to FIG. 7, it can be seen that a golf club is gripped using the sports glove 10. First, the hand can be placed with the palm facing upward in the state in which the hand is fully extended (see (a) of FIG. 6). In this case, a guideline GL may be marked on the palm part 11. The guideline GL may be marked at the position where the handle portion is seated on the palm part 11 to appropriately grip the golf club.

Next, the handle of the golf club may be disposed adjacent to the individual finger connection portions of the palm, and may be disposed parallel to the direction in which the first inclined portion 122 of the support 12 is horizontally extended (see (b) of FIG. 6). A user may dispose the handle of the golf club along the guideline GL. The direction in which the hypotenuse of the top surface portion 121 of the support 12 is horizontally extended may be formed to be parallel to the direction in which the guideline GL is extended.

Next, the golf club may be held weakly (see (c) of FIG. 6). In this case, the rounded outer surface of the golf club may be disposed adjacent to the first inclined portion 122 of the support 12. Next, the golf club may be held strongly (see (d) of FIG. 6). In this case, the rounded outer surface of the golf club is completely brought into close contact with a portion of the palm part 11 corresponding to the first inclined portion 122 of the support 12, so that the golf club can be completely fixed in terms of position. When a golf swing is performed in this state, there are effects in that the golf club does not move in the palm and consistent golf swing may be performed.

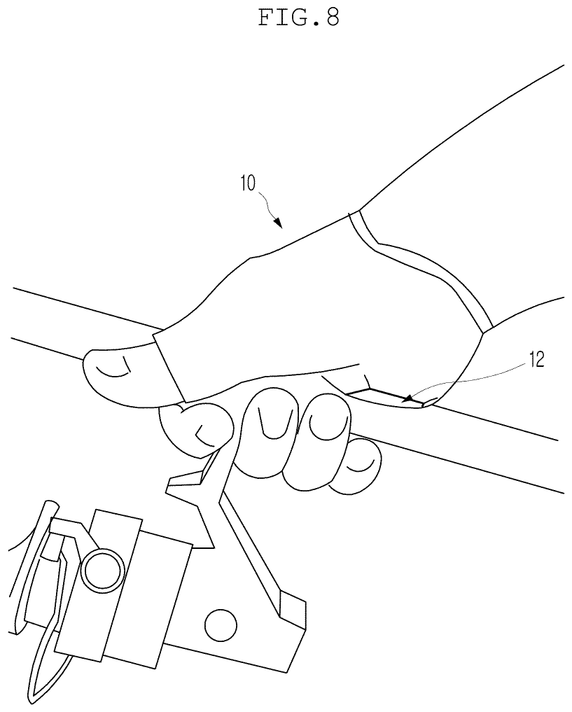

FIG. 8 is a drawing showing a state in which a fishing rod is gripped with a sports glove 10 according to an embodiment of the present disclosure.

Referring to FIG. 8, when a fishing rod is gripped using the sports glove 10 according to the present embodiment, the position of the fishing rod is not moved in the palm, so that the fishing rod can be comfortably held motionless for a long time with the consumption of gripping force reduced. Furthermore, there is an advantage in that the handle is desirably fixed when the fishing rod is thrown or pulled, so that the fishing rod can be used with a sense of stability.

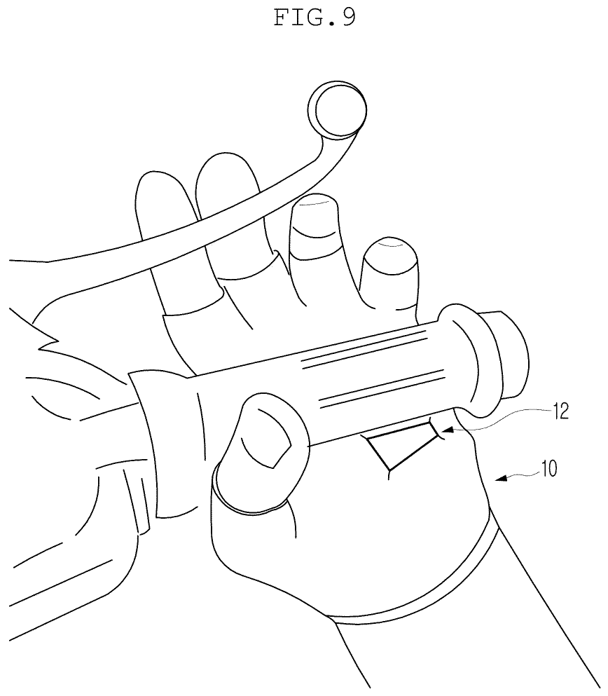

FIG. 9 is a diagram showing a state in which a bike handle is gripped with a sports glove 10 according to an embodiment of the present disclosure.

Referring to FIG. 9, when a bike handle is gripped using the sports glove 10 according to the present embodiment, the palm is comfortably seated on the handle and supported by the support 12, so that the handle can be prevented from being separated from the palm. Furthermore, the gripping force consumed to hold the handle is reduced, so that the fatigue applied to the hand can be reduced when a user rides a bike for a long time.

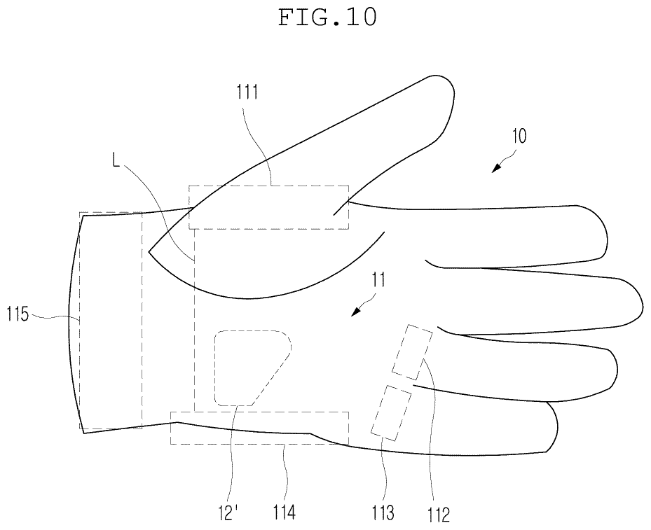

FIG. 10 is a drawing showing a sports glove 10 according to another embodiment of the present disclosure.

Referring to FIG. 10, the sports glove 10 according to another embodiment of the present disclosure may include a similar support 12′ instead of the support 12 according to the above-described embodiment.

The support 12′ may include a polyurethane foam material like the above-described support 12. Furthermore, the support 12′ may include various materials such as natural rubber and silicone as well as polyurethane foam. Overall, the support 12′ according to another embodiment of the present disclosure may be formed to be lower than the support 12 according to an embodiment of the present disclosure and may not include individual inclined portions. This support 12′ may increase the thickness of a portion of the palm part disposed on the mount of the Moon of the palm of the hand. Furthermore, the overall shape of the support 12′ may be formed to be a trapezoidal or triangular shape, so that the direction in which the hypotenuse is extended horizontally may be formed in the direction between a thumb connection portion and an index finger connection portion. In this manner, the direction in which a stick such as a golf club is placed on the palm portion may be guided. Furthermore, when a user having large hands holds a stick of a small diameter in a cylinder shape, there is a difficulty in hat the stick shakes or moves in the hand. When the support 12′ is disposed on the palm, the user having large hands may securely hold the stick of a small diameter in a cylinder shape.

Furthermore, the sports glove 10 according to the present embodiment may be used when a user engages in leisure sports using a stick or poles, such as skiing or mountaineering. Accordingly, the user may hold the stick or poles with more stability, so that there is an effect of preventing safety-related accidents that may occur due to the separation of a stick or pole from the palm.

The sports glove 10 according to the present disclosure described above includes the support 12, and has the effect of enabling a user to stably hold each club or stick when playing a sport using a sports club or stick, such as golf, fishing, bike riding, skiing, or mountaineering.

In particular, the sports glove 10 according to the present disclosure includes the support 12, so that when a user grips a golf club, the support 12 supports the handle of the golf club. Accordingly, during a fast golf swing, the golf club may be prevented from moving or shaking in the palm, and an accurate swing may be made.

The above-described various embodiments of the present disclosure may be combined with additional embodiments, and may be modified within a range that can be understood by those skilled in in light of the detailed description set forth above. It should be understood that the embodiments of the present disclosure are illustrative and not restrictive in all respects. For example, each component described as a single unit may be implemented in a distributed manner, and likewise, components described as distributed may be implemented in a combined manner. Therefore, all changes or modifications derived from the meanings, scopes, and equivalent concepts of the claims of the present disclosure should be interpreted as being included in the scope of the present disclosure.

1. A sports glove, comprising a support disposed on a portion of a palm part of the glove;
wherein the support is configured such that a width thereof measured on a vertical plane, through which a first imaginary line connecting a thumb connection portion and a hand blade portion on the palm part passes, becomes narrower in a direction toward the hand blade portion along the first imaginary line.

2. The sports glove of claim 1, wherein the support comprises a polyurethane foam material.

3. The sports glove of claim 1, wherein the support is disposed on an inner side of an outer skin of the palm part and is also disposed to protrude upward from the palm part of the glove, and the horizontal width of the support measured on the vertical plane becomes narrower in an upward direction.

4. The sports glove of claim 3, wherein the support is disposed between outer and inner skins of the palm part of the glove.

5. The sports glove of claim 3, wherein the support comprises:
a top surface; and
a first inclined portion formed by taking a downward slope from one side of the top surface toward a little finger connection portion.

6. The sports glove of claim 5, wherein the first inclined portion is formed to be rounded such that a slope thereof becomes gentler in a downward direction.

7. The sports glove of claim 5, wherein the support comprises a second inclined portion formed by taking a downward slope from one side of the top surface toward the thumb connection portion.

8. The sports glove of claim 5, wherein the support comprises a third inclined portion formed by taking a downward slope from one side of the top surface toward a wrist portion.

9. The sports glove of claim 1, wherein the support is disposed between the thumb connection portion and the hand blade portion, and is also disposed closer to the hand blade portion.

10. The sports glove of claim 9, wherein the support is disposed between a ring finger connection portion and a little finger connection portion, and a wrist portion, and is also disposed closer to the wrist portion.
